(19) United States
(12) Patent Application Publication
(10) Pub. No.: US 2006/0022745 A1
(43) Pub. Date: Feb. 2, 2006

(54) Semiconductor integrated circuit device

(75) Inventor: Hiroshi Nakamura, Fujisawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/184,918

(22) Filed: Jul. 20, 2005

(30) Foreign Application Priority Data
Jul. 27, 2004 (JP) 2004-218772

(51) Int. Cl. G05F 1/10

(52) U.S. Cl. 327/541

(57) ABSTRACT

A semiconductor integrated circuit device includes: a circuit node to be set at a certain operating voltage; and a voltage stabilizing capacitor connected to the circuit node, wherein the voltage stabilizing capacitor is formed of at least two MOS capacitors coupled in parallel with each other, which show different capacitance changes from each other in accordance with an applied voltage change.

### CROSS-REFERENCE TO RELATED APPLICATION

This application is based on and claims the benefit of priority from the prior Japanese Patent Application No. 2004-218772, filed on Jul. 27, 2004, the entire contents of which are incorporated herein by reference.

### BACKGROUND OF THE INVENTION

1. Field of the Invention

This invention relates to a semiconductor integrated circuit device with a voltage stabilizing capacitor.

2. Description of Related Art

In the technical field of semiconductor integrated circuit devices, a voltage generating circuit is often used for generating a constant voltage lower than the power supply voltage. For example, a regulated voltage generation circuit is well-known, which is constituted by a differential amplifier of a current-mirror type. One of two input nodes of the differential amplifier, i.e., an inverting input node, is applied with a reference voltage. A voltage outputting circuit is driven by the differential amplifier, and output voltage thereof is subjected to feed-back to a non-inverting input node of the differential amplifier. With this arrangement, the regulated voltage generation circuit is able to output a voltage equal to the reference voltage.

To prevent such the voltage generation circuit from being oscillated, and to stabilize the output voltage, there is provided a voltage stabilizing capacitor disposed between the non-inverting input node and the output node so as to short-circuit therebetween (refer to, for example, Unexamined Japanese Patent Application Publication No. 11-161353).

If the capacitance of the above-described voltage stabilizing capacitor used in the regulated voltage generation circuit is small, the responsibility to the operation voltage variation becomes so high that there is a fear of oscillation. Therefore, it is in need of using a capacitor with a capacitance value larger than a certain level. In a semiconductor integrated device, it is usually used a capacitor formed of MOS transistor(s) (refer to as a MOS capacitor hereinafter). Since the capacitance of the MOS capacitor is dependent on the applied voltage, the capacitance of the stabilizing capacitor is largely varied due to the above-described voltage variation. Under the condition of that the capacitance of the stabilizing capacitor becomes minimum, it is difficult to stabilize the output voltage. By contrast, if the MOS capacitor is formed with a large size for increasing the capacitance, this leads to circuit area increase.

### SUMMARY OF THE INVENTION

According to one aspect of the present invention, there is provided a semiconductor integrated circuit device including: a circuit node to be set at a certain operating voltage; and a voltage stabilizing capacitor connected to the circuit node, wherein the voltage stabilizing capacitor is formed of at least two MOS capacitors coupled in parallel with each other, which show different capacitance changes from each other in accordance with an applied voltage change.

According to another aspect of the present invention, there is provided a semiconductor integrated circuit device including: a differential amplifier; and a voltage stabilizing capacitor connected between the input and output nodes of the differential amplifier, the voltage stabilizing capacitor being formed of at least two MOS capacitors coupled in parallel with each other, which show different capacitance changes from each other in accordance with an applied voltage change.

According to another aspect of the present invention, there is provided a semiconductor integrated circuit device with a voltage generation circuit, the voltage generation circuit including: a differential amplifier having an inverting input node, a non-inverting input node and an output node, the inverting input node being applied with a reference voltage; a voltage output circuit, the input node of which is coupled to the output node of the differential amplifier, the output voltage of the voltage output circuit being subjected to negative feedback to the non-inverting input node; and a voltage stabilizing capacitor connected between the non-inverting input node and the output node of the differential amplifier, the voltage stabilizing capacitor being formed of at least two MOS capacitors coupled in parallel with each other, which show different capacitance changes from each other in accordance with an applied voltage change.

### BRIEF DESCRIPTION OF THE DRAWINGS

FIG. 1 shows a voltage generation circuit in accordance with an embodiment of the present invention.

FIG. 2 shows another voltage generation circuit.

FIG. 3 shows another voltage generation circuit.

FIG. 4 shows configuration examples of the voltage stabilizing capacitor used in the embodiment.

FIG. 5 shows other configuration examples of the voltage stabilizing capacitor used in the embodiment.

FIG. 6 shows other configuration examples of the voltage stabilizing capacitor used in the embodiment.

FIG. 7 shows other configuration examples of the voltage stabilizing capacitor used in the embodiment.

FIG. 8 shows a MOS capacitor with a structure and a symbol thereof used in the embodiment.

FIG. 9 shows another MOS capacitor with a structure and a symbol thereof used in the embodiment.

FIG. 10 shows another MOS capacitor with a structure and a symbol thereof used in the embodiment.

FIG. 11 shows another MOS capacitor with a structure and a symbol thereof used in the embodiment.

FIG. 12 shows another MOS capacitor with a structure and a symbol thereof used in the embodiment.

FIG. 13 shows another MOS capacitor with a structure and a symbol thereof used in the embodiment.

FIG. 14 shows another MOS capacitor with a structure and a symbol thereof used in the embodiment.

FIG. 15 shows another MOS capacitor with a structure and a symbol thereof used in the embodiment.

FIG. 16 shows a well structure used for the MOS capacitor.

FIG. 17 shows another well structure used for the MOS capacitor.

FIG. 18 shows another well structure used for the MOS capacitor.

FIG. 19 shows another well structure used for the MOS capacitor.

FIG. 20 shows another well structure used for the MOS capacitor.

FIG. 21 shows another well structure used for the MOS capacitor.

FIG. 22 shows a C-V curve C1 of E-type NMOS capacitor.

FIG. 23 shows a C-V curve C2 of PMOS capacitor.

FIG. 24 shows a C-V curve C3 of D-type NMOS capacitor.

FIG. 25 shows a composed C-V curve based on curves C1 and C2.

FIG. 26 shows a composed C-V curve based on curves C1 and C3.

FIG. 27 shows a composed C-V curve based on curves C1 and C1.

FIG. 28 shows cut-off and transferring conditions of D-type NMOS transistor.

FIG. 29 shows cut-off and transferring conditions of E-type NMOS transistor.

FIG. 30 shows layout examples of the MOS capacitor.

FIG. 31 shows other node configuration examples of the MOS capacitor.

FIG. 32 shows a voltage generation circuit in accordance with another embodiment.

FIG. 33 shows a voltage generation circuit in accordance with another embodiment.

FIG. 34 shows another voltage generation circuit.

FIG. 35 shows another voltage generation circuit.

FIG. 36 shows another voltage generation circuit.

FIG. 37 shows another voltage generation circuit.

FIG. 38 shows another voltage generation circuit.

FIG. 39 shows another voltage generation circuit.

FIG. 40 shows another voltage generation circuit.

FIG. 41 shows another voltage generation circuit.

FIG. 42 shows another voltage generation circuit.

FIG. 43 shows another voltage generation circuit.

FIG. 44 shows voltage stabilizing capacitor examples used in the circuits shown in FIGS. 32 to 37 and FIGS. 40 to 43.

FIG. 45 shows other voltage stabilizing capacitor examples used in the circuits shown in FIGS. 32 to 37 and FIGS. 40 to 43.

FIG. 46 shows other voltage stabilizing capacitor examples used in the circuits shown in FIGS. 32 to 37 and FIGS. 40 to 43.

FIG. 47 shows other voltage stabilizing capacitor examples used in the circuits shown in FIGS. 32 to 37 and FIGS. 40 to 43.

FIG. 48 shows other voltage stabilizing capacitor examples used in the circuits shown in FIGS. 32 to 37 and FIGS. 40 to 43.

FIG. 49 shows other voltage stabilizing capacitor examples used in the circuits shown in FIGS. 32 to 37 and FIGS. 40 to 43.

FIG. 50 shows other voltage stabilizing capacitor examples used in the circuits shown in FIGS. 32 to 37 and FIGS. 40 to 43.

### DETAILED DESCRIPTION OF THE EMBODIMENTS

Illustrative embodiments of this invention will be explained with reference to the accompanying drawings below.

In the present invention and embodiments described below, a so-called “MOS (Metal Oxide Semiconductor) transistor” or “MOS capacitor” includes not only a case, in which gate insulating film thereof is formed of a silicon dioxide film, but also another case, in which it is formed of a certain insulator film except oxide.

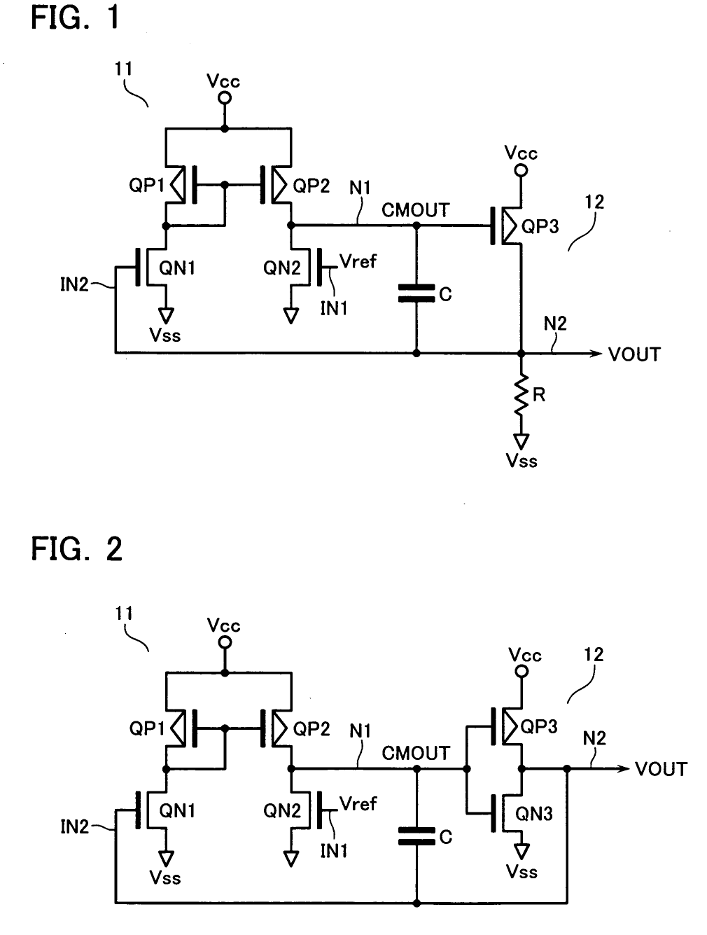

FIGS. 1 to 3 show examples of voltage generation circuits used in a semiconductor integrated device. Each of these voltage generation circuits is formed of a deferential amplifier 11 of a current-mirror type and a voltage output circuit 12 for receiving output thereof.

In the circuits shown in FIGS. 1 and 2, differential amplifier 11 has a current-mirror type of load circuit formed of PMOS transistors QP1 and QP2 and a driver with differential NMOS transistors QN1 and QN2 connected to the load circuit. Applied to an inverting input node IN1 (i.e., gate node of NMOS transistor QN2) of the differential amplifier 11 is reference voltage Vref.

In the circuit shown in FIG. 1, voltage CMOUT at the output node N1 of the differential amplifier 11 is input to a gate of current source PMOS transistor QP3 of the voltage output circuit 12, and drain thereof serves as a voltage output node N2. This voltage output node N2 is connected to ground potential Vss via a load resistor R, and the output voltage VOUT is subjected to feedback to a non-inverting input node IN2 (i.e., gate node of NMOS transistor QN1) of the differential amplifier 11. According to this negative feedback control, the output voltage VOUT is regulated to be equal to the reference voltage Vref.

In the circuit shown in FIG. 2, the voltage output circuit 12 is a CMOS amplifier formed of PMOS transistor QP3 and NMOS transistor QN3.

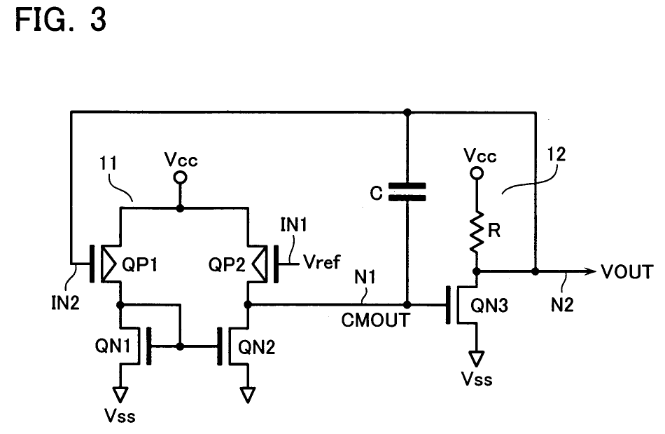

In the differential amplifier 11 shown in FIG. 3, NMOS transistors QN1 and QN2 constitute a current-mirror type of load circuit, and differential PMOS transistors QP1 and QP2 constitute a driver. In accordance with this arrangement, the voltage output circuit 12 serves as an inverting amplifier with NMOS transistor QN3 and a load resistor R disposed between drain thereof and the power supply node Vcc.

As common to the voltage generation circuits shown in FIGS. 1 to 3, an oscillation preventing (i.e., voltage stabilizing) capacitor C is disposed between the output node N1 and the non-inverting input node IN2 of the differential amplifier 11. To show the oscillation preventing function, it is required of the voltage stabilizing capacitor C to have a capacitance larger than a certain value. For this purpose, the voltage stabilizing capacitor C is formed of at least two MOS capacitors connected in parallel with each other in this embodiment.

Note here that different kinds of MOS transistors (i.e., these are different from each other in property, in direction (polarity), or in structure) are used for two MOS capacitors connected in parallel with each other so that these show different capacitance changes in accordance with a voltage change of the node, to which the capacitors are coupled. To combine different kinds of MOS transistors, these may be coupled with the same direction (i.e., gates thereof are interconnected) or with the reverse direction (i.e., gate of one transistor is coupled to source/drain of the other). Alternatively, it is effective to combine the same kind of MOS transistors in such a manner that these are inverted in direction and coupled in parallel with each other.

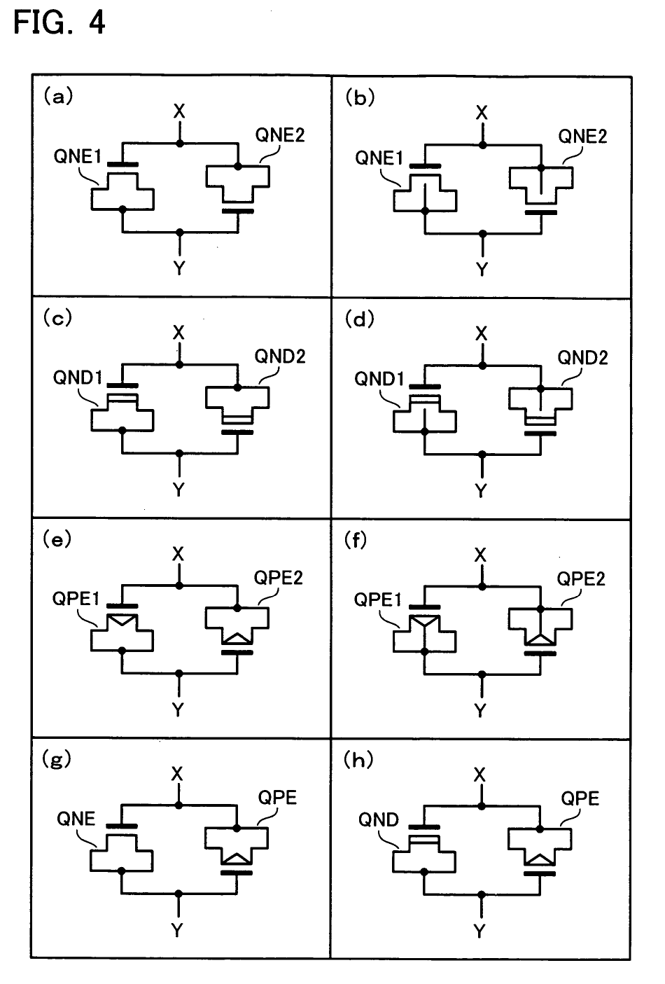

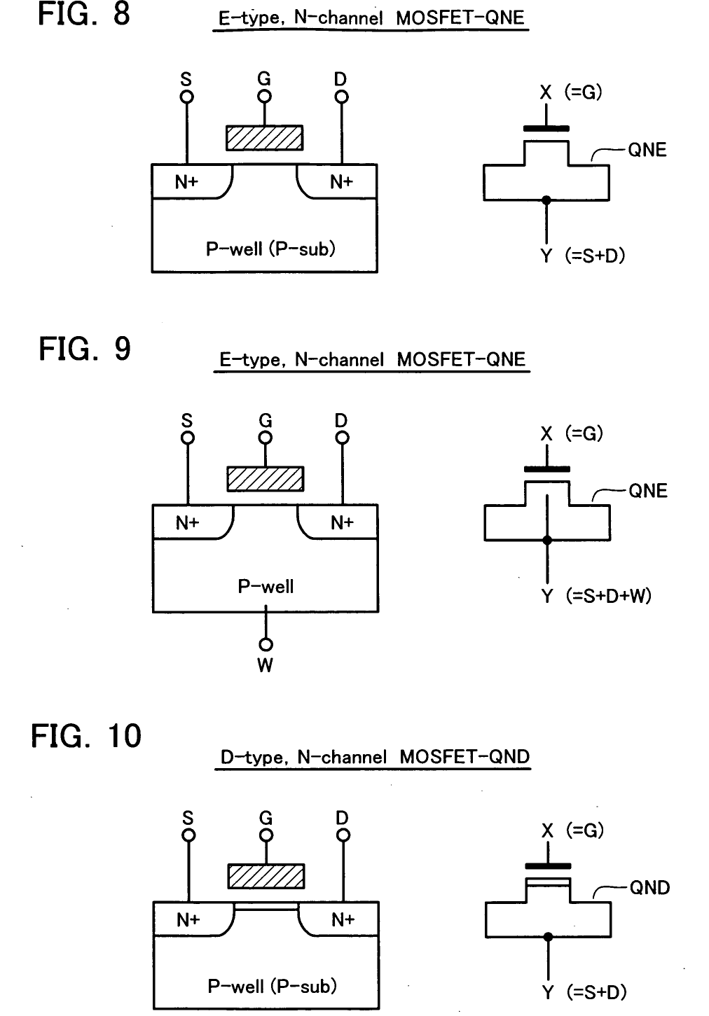

FIGS. 4 to 7 show connection examples of MOS capacitors. Symbols and structures of these MOS capacitors are shown in FIGS. 8 to 15.

FIG. 8 shows a MOS capacitor formed of an enhancement-type (hereinafter, refer to as E-type) and N-channel type of MOS transistor (hereinafter, refer to as NMOS transistor) QNE, N⁺-type of source and drain of which are formed on a P-type well (or substrate). This NMOS transistor QNE is used as a MOS capacitor, in which gate G serves as a first capacitor node X; and source S and drain D as a second capacitor node Y. In FIG. 4(a), these two MOS capacitors QNE1 and QNE2 are coupled in parallel with each other and with the reverse directions.

FIG. 9 shows a MOS capacitor formed of the same E-type NMOS transistor QNE as that shown in FIG. 8, in which P-type well W serves as the second capacitor node Y together with source S and drain D. In FIG. 4(b), reversely directed two MOS capacitors QNE1 and QNE2 are coupled in parallel with each other. With this structure, in which P-type well W serves as the second capacitor node Y together with source S and drain D, the threshold voltage variation due to substrate-bias effect may be suppressed, thereby resulting in that a static characteristic is obtained.

FIG. 10 shows a MOS capacitor formed of a depletion-type (hereinafter, refer to as D-type) of NMOS transistor QND, in which gate G serves as a first capacitor node X; and source S and drain D as a second capacitor node Y. FIG. 4(c) shows an example, in which these two MOS capacitors QND1 and QND2 are coupled in parallel with each other with the reverse directions.

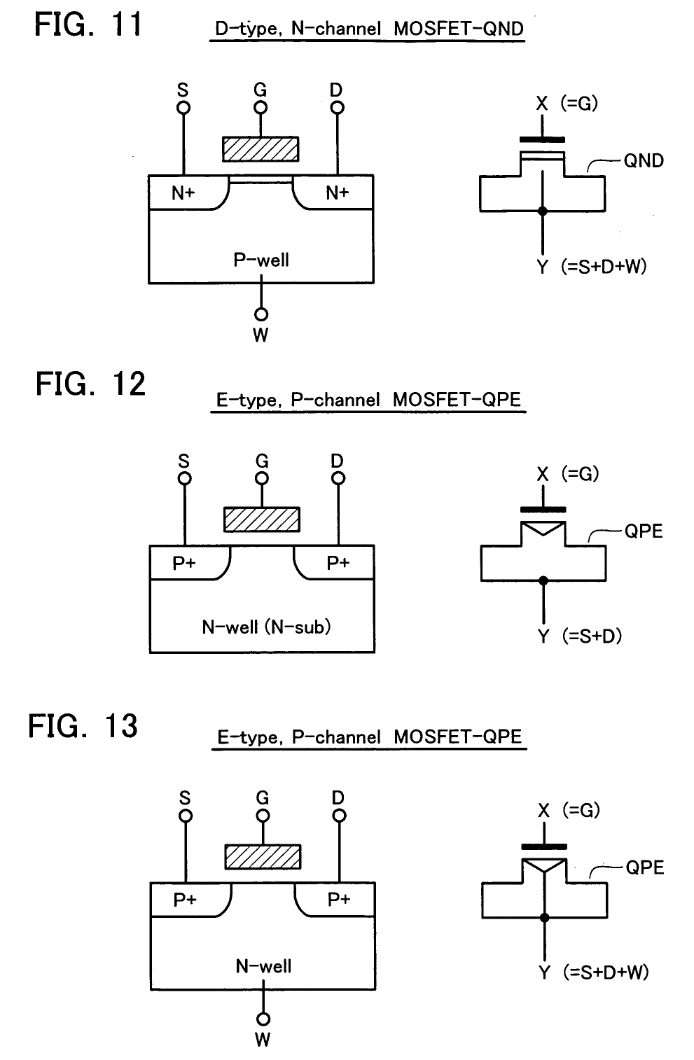

FIG. 11 shows a MOS capacitor formed of the same D-type NMOS transistor QND as that shown in FIG. 10, in which P-type well W serves as the second capacitor node Y together with source S and drain D. In FIG. 4(d), these two MOS capacitors QND1 and QND2 are coupled in parallel with each other with the reverse directions.

FIG. 12 shows a MOS capacitor formed of an E-type of and P-channel type of MOS transistor (hereinafter, refer to as PMOS transistor) QPE, P⁺-type of source and drain of which are formed on an N-type well (or substrate). This PMOS transistor QPE is used as a MOS capacitor, in which gate G serves as a first capacitor node X; and source S and drain D as a second capacitor node Y. In FIG. 4(e), reversely directed MOS capacitors QPE1 and QPE2 are coupled in parallel with each other.

FIG. 13 shows a MOS capacitor formed of the same E-type PMOS transistor QPE as that shown in FIG. 12, in which N-type well W serves as the second capacitor node Y together with source S and drain D. In FIG. 4(f), these two MOS capacitors QPE1 and QPE2 are coupled in parallel with the reverse directions.

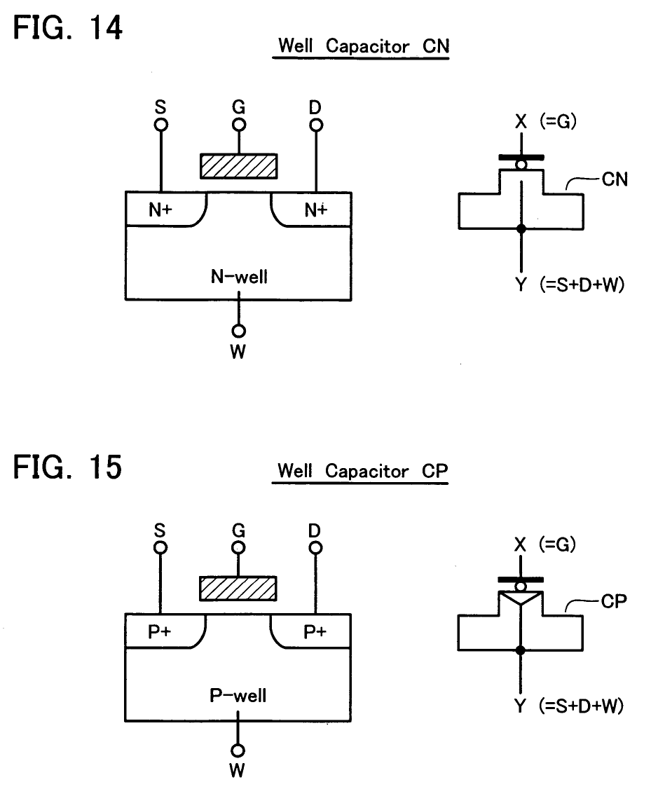

MOS capacitors may be formed with device structures as shown in FIGS. 14 and 15, each of which is not used in general as a MOS transistor. The MOS capacitor shown in FIG. 14 has N⁺-type source and drain formed on an N-type well, and the MOS capacitor shown in FIG. 15 has P⁺-type source and drain formed on a P-type well. These MOS capacitors will be referred to as “well capacitors” CN and CP with the symbols shown in FIGS. 14 and 15, respectively.

Each of the examples (a) to (f) shown in FIG. 4 is formed as a combination of the same type of MOS capacitors. Since, in these examples, two MOS capacitors are coupled as reversely directed, these show different capacitance changes from each other in accordance with the voltage change of the node X or Y. Therefore, the whole capacitance change will be suppressed to a small level.

In a case that different kinds of MOS capacitors are coupled in parallel with each other, the capacitance variation due to the voltage change will be reduced in a small level, whichever connection, the reverse direction or the same direction, is used. In the example (g) shown in FIG. 4, E-type NMOS transistor QNE and E-type PMOS transistor QPE are coupled in parallel with the reverse directions. In the example (h) shown in FIG. 4, D-type NMOS transistor QND and E-type PMOS transistor QPE are coupled in parallel with the reverse directions.

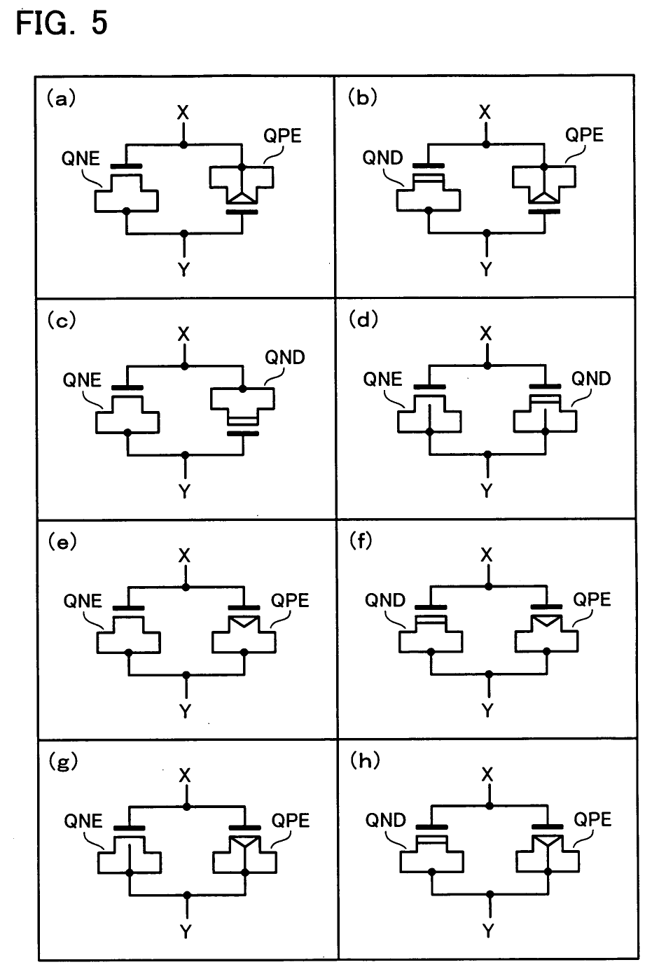

FIGS. 5(a) and (b) show variations of the examples shown in FIGS. 4(g) and (h), respectively, in each of which N-type well of the PMOS transistor QPE is coupled to source and drain thereof. FIG. 5(c) is an example, in which E-type NMOS transistor QNE and D-type NMOS transistor QND are coupled in parallel with the reverse directions. FIG. 5(d) is an example, in which E-type NMOS transistor QNE and D-type NMOS transistor QND are coupled in parallel with the same direction (i.e., gates thereof are interconnected).

FIG. 5(e) is an example, in which E-type NMOS transistor QNE and E-type PMOS transistor QPE are coupled in parallel with each other with gates thereof interconnected. FIG. 5(f) is an example, in which D-type NMOS transistor QND and E-type PMOS transistor QPE are coupled in parallel with each other in such a manner that gates thereof are interconnected.

FIG. 5(g) shows a variation of FIG. 5(e), in which wells of these transistors are coupled to source/drains thereof, respectively. FIG. 5(h) shows a variation of FIG. 5(f), in which N-type well of PMOS transistor QPE is coupled to source/drain thereof.

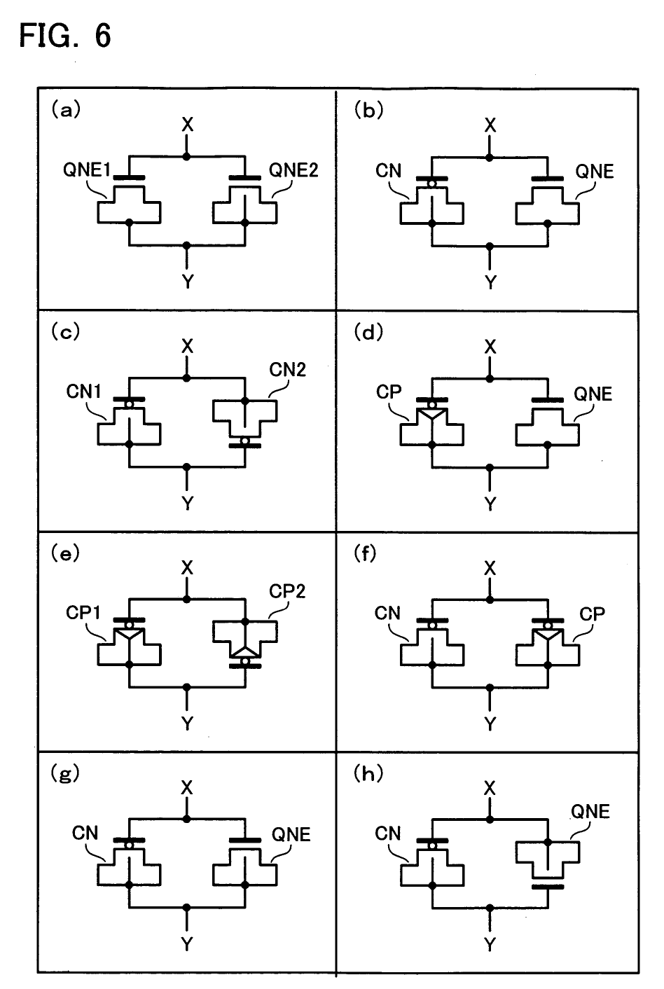

FIG. 6(a) is an example, in which two E-type NMOS transistors QNE1 and QNE2 are coupled in parallel in such a connection way that P-type well is not coupled to the capacitor node in one of these, QNE1, while P-type well is coupled to the capacitor node in the other, QNE2. FIG. 6(b) is an example, in which N-channel well capacitor CN and E-type NMOS transistor QNE are coupled in parallel to each other; and FIG. 6(c) is an example, in which the same type of (i.e., N-channel type of) two well capacitors CN1 and CN2 are coupled in parallel with the reverse directions.

FIG. 6(d) is an example, in which P-channel well capacitor CP and E-type NMOS transistor QNE are coupled in parallel to each other. FIG. 6(e) is an example, in which the same type of (i.e., P-channel type of) two well capacitors CP1 and CP2 are coupled in parallel with the reverse directions.

FIG. 6(f) is an example, in which N-channel well capacitor CN and P-channel well capacitor CP are coupled in parallel with each other with gates thereof interconnected. FIG. 6(g) is an example, in which well capacitor CN and E-type NMOS transistor QNE are coupled in parallel with each other in such a manner that gates thereof are interconnected. FIG. 6(h) shows an example, E-type NMOS transistor QNE is coupled to well capacitor CN with the reverse directions as different from that shown in FIG. 6(g).

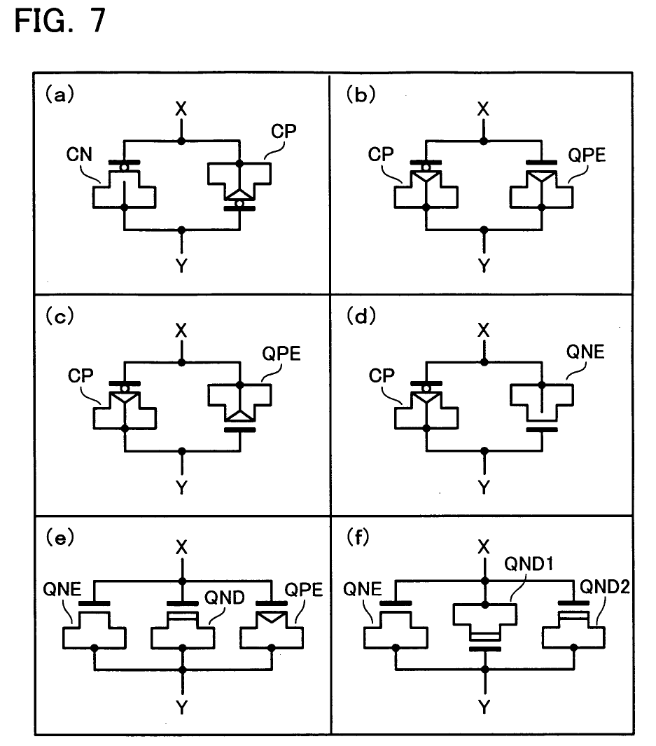

FIG. 7(a) shows an example, in which N-channel well capacitor CN and P-channel well capacitor CP are coupled in parallel with each other with the reverse directions. FIG. 7(b) is an example, in which P-channel well capacitor CP and PMOS transistor QPE are coupled in parallel with each other with gates thereof interconnected. FIG. 7(c) is an example, in which P-channel well capacitor CP and PMOS transistor QPE are coupled in parallel with each other with the reverse directions. FIG. 7(d) is an example, in which P-channel well capacitor CP and NMOS transistor QNE are coupled in parallel with each other with the reverse directions.

FIGS. 7(e) and (f) show typical examples, in which three MOS transistors are coupled in parallel. Various combinations except those shown in FIGS. 7(e) and (f) may be used under the condition of that it is satisfied with the following relationship of: at least two of three transistors have different kinds of structures, or are coupled with inverted directions, or show different capacitance changes from each other in accordance with the voltage change of the node, to which these are coupled.

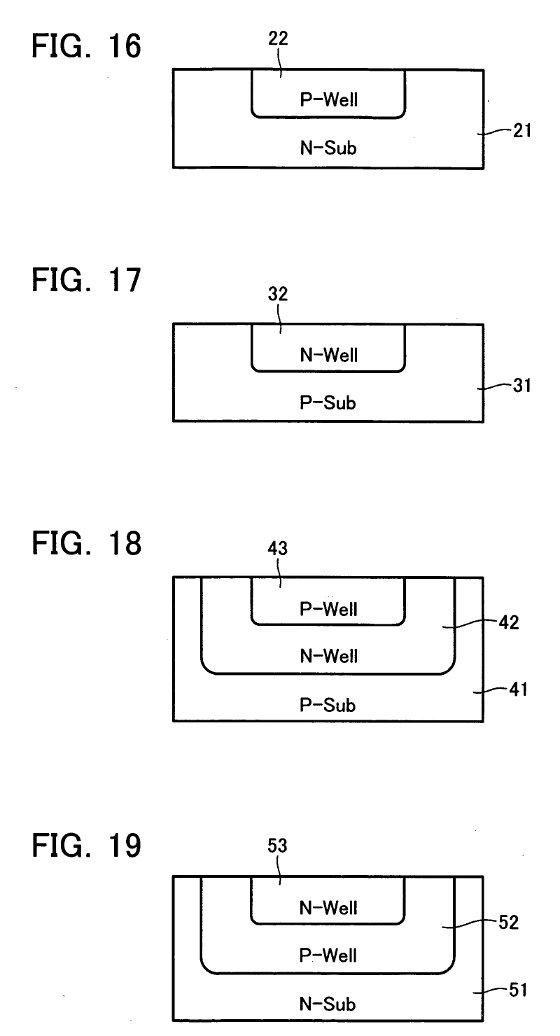

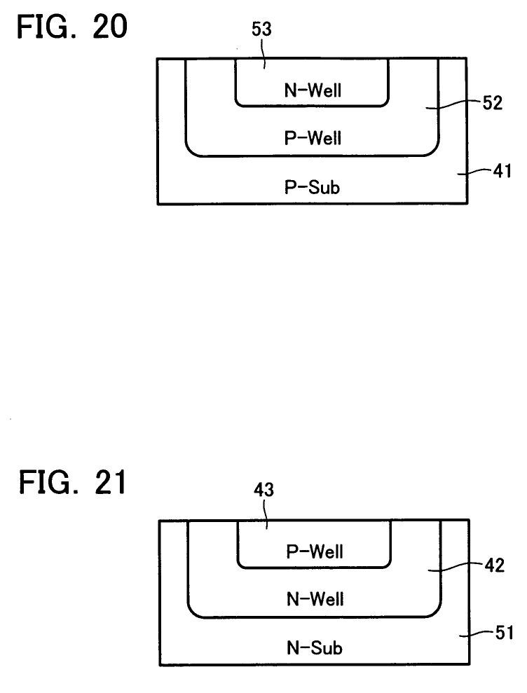

FIGS. 16 to 21 show some examples of the well structure, on which the above-described MOS transistors (MOS capacitors) are formed. FIG. 16 shows a well structure having an N-type semiconductor substrate 21 and a P-type well 22 formed thereon. FIG. 17 shows another well structure having a P-type semiconductor substrate 31 and an N-type well formed thereon. FIG. 18 shows a double well structure having a P-type semiconductor substrate 41 and an N-type well 42 formed thereon, and further having a P-type well 43 formed on the N-type well 42. FIG. 19 shows another double well structure having an N-type semiconductor substrate 51 and a P-type well 52 formed thereon, and further having an N-type well 53 formed on the P-type well 52. FIG. 20 shows another well structure having a P-type semiconductor substrate 41 and a P-type well 52 formed thereon, and further having an N-type well 53 formed on the P-type well 52. FIG. 21 shows still another well structure having an N-type semiconductor substrate 51 and an N-type well 42 formed thereon, and further having a P-type well 43 formed on the N-type well 42.

The above-described examples shown in FIGS. 4 to 7 are constituted by at least two MOS capacitors, which show different capacitance changes due to a voltage change between nodes, are coupled in parallel with each other. These examples are classified into two groups as follows. A first group is characterized in that two kinds of MOS capacitors with different structures or properties are coupled. Note here that the difference on the “structure” or “property” includes the following some cases: difference between N-channel and P-channel; difference between E-type and D-type (i.e., threshold voltage difference); and difference between threshold voltages in a case that MOS capacitors have the same channel conductivity type, or of the same E-type or D-type. A second group is characterized in that two MOS capacitors with the same structure or the same property are coupled with the reverse directions in parallel with each other. The examples (a) to (f) in FIG. 4 belong to the above-described second group. It is effective in these cases because two MOS capacitors show different capacitance changes due to the voltage change between the nodes.

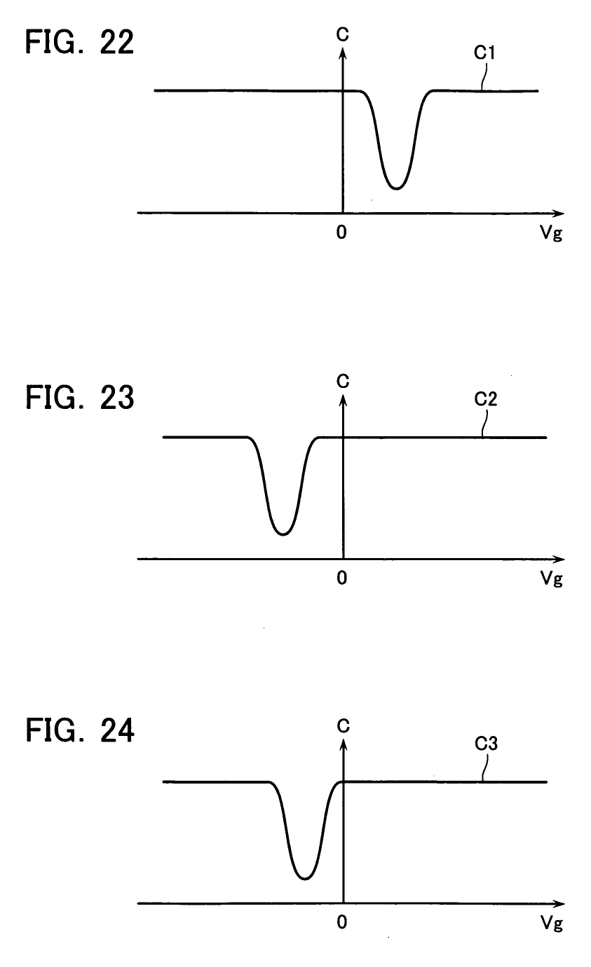

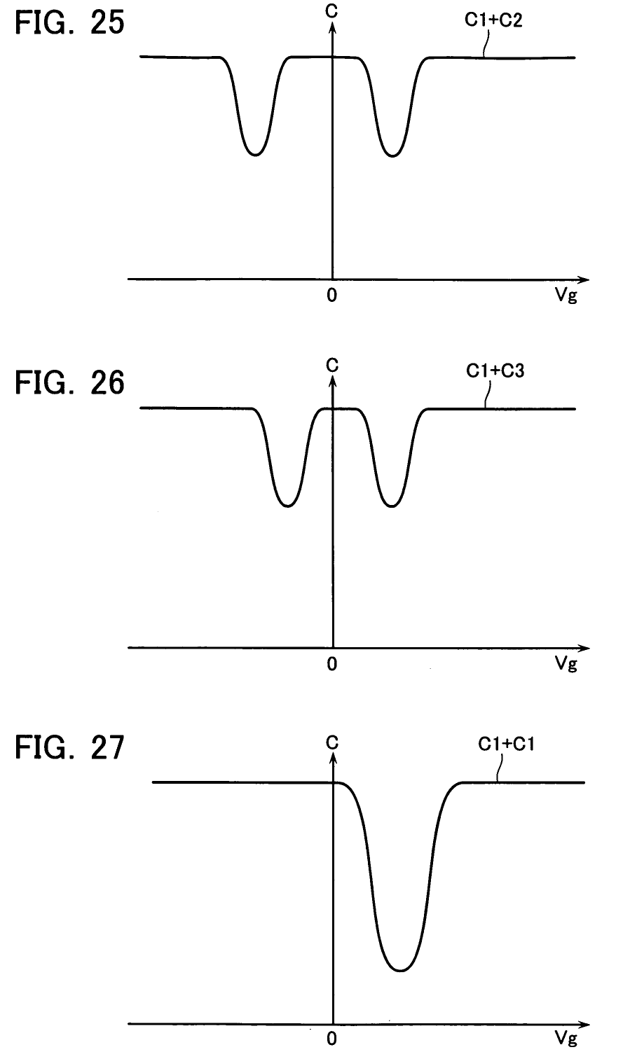

With reference to C-V curves shown in FIGS. 22 to 27, the effectiveness of the above-described embodiment will be explained below. FIG. 22 shows C-V curve C1 of an E-type NMOS transistor, which expresses a relationship between gate voltage Vg and capacitance C under the condition of that source, drain and well thereof are set at ground potential. When gate voltage Vg is nearly equal to 0V, the capacitance is substantially determined by the gate insulating film. As the gate voltage becomes higher, the capacitance will be decreased because a depletion layer's capacitance is added in series to the gate insulating film's capacitance near a threshold voltage. As an inverted layer is generated under the gate, the capacitance will be increased again.

FIG. 23 shows a C-V curve C2 of E-type PMOS transistor QPE; and FIG. 24 shows a C-V curve C3 of D-type NMOS transistor QND. These C-V curves may also be measured under the condition of that source, drain and well are set at ground potential, and have a minimum value in the negative voltage region because these devices have a negative threshold voltage.

If two MOS transistors with C-V curve C1 shown in FIG. 22 are coupled in parallel with each other with the same direction, a composed C-V curve may be obtained as shown in FIG. 27. That is, the capacitance value becomes double, but it shows a large capacitance change near the threshold voltage, and a difference between the maximum value and the minimum value of the capacitance (i.e. the rate of capacitance change) becomes large.

By contrast to this, compose the C-V curve C1 shown in FIG. 22 and the C-V curve C3 shown in FIG. 24, and a composed C-V curve is obtained as shown in FIG. 26. As a result, it should be appreciated that in case different kinds of MOS capacitors are coupled in parallel with each other, not only the capacitance value is double in a region far from the threshold voltage, but also the minimum capacitance value near the threshold voltage of one capacitor may be boosted due to a large capacitance value of the other capacitor. In other words, the minimum capacitance value becomes larger and the capacitance change due to the voltage change may be suppressed more in comparison with the case shown in FIG. 27.

Therefore, in case the capacitor examples shown in FIGS. 4 to 7, are adapted to the capacitor C in the voltage generation circuits shown in FIGS. 1 to 3, the capacitance change due to the voltage change of the node N1 or N2 may be suppressed in a small level. In other words, even if the operation voltage is varied, there is provided a steady oscillation preventing function.

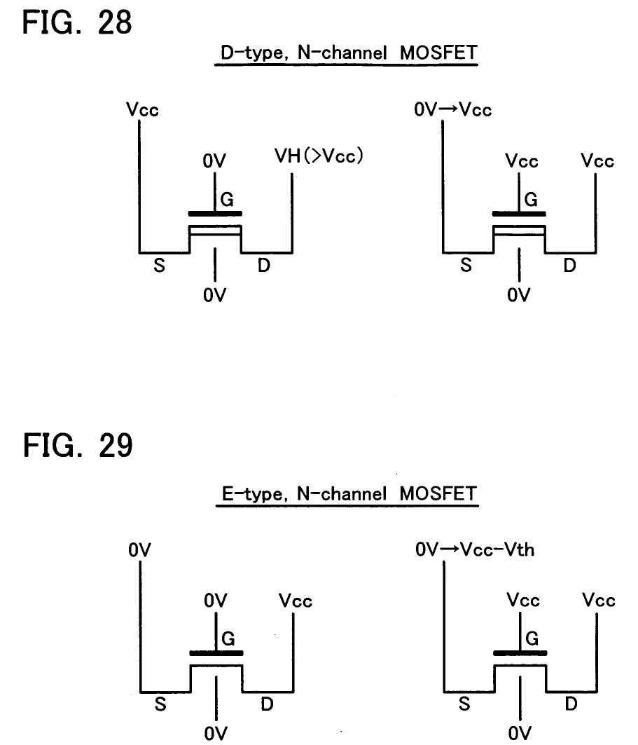

FIGS. 28 and 29 show operation conditions of normal NMOS transistors. In FIG. 28, a cut-off condition and a voltage transferring condition are shown with respect to a D-type NMOS transistor. In case the gate is applied with 0V; and the source with power supply voltage Vcc, the transistor becomes cut-off under the condition that voltage VH higher than the power supply voltage is applied to drain. If the gate is applied with Vcc, Vcc applied to the drain may be transferred to the source without voltage dropping.

FIG. 29 shows a cut-off condition and a voltage transferring condition of an E-type NMOS transistor. In case the gate is applied with 0V; and the drain with Vcc, the transistor is cut-off, so that the drain voltage is not transferred to the source. If the gate is applied with Vcc; and the drain with Vcc, Vcc-Vth (Vth: threshold voltage) is transferred to the source, thereby cutting-off the transistor.

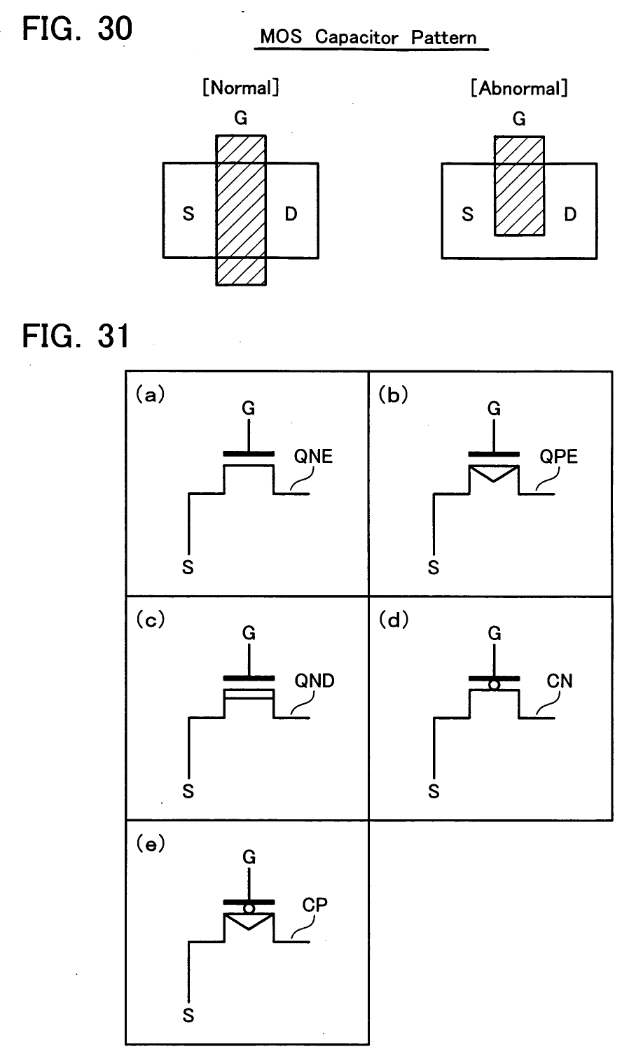

FIG. 30 shows examples of MOS capacitor patterns. Usually, gate G is formed as crossing over the device region as similar to a normal MOS transistor, and source S and drain D are formed at the both sides of gate G. The above-described embodiment is on the assumption of that such the normal pattern is used.

By contrast, it may be used such a specifically patterned MOS capacitor that gate G incompletely crosses the device region as shown in FIG. 30 because source S and drain D are set at the same potential in the MOS capacitor. In this case, the source S and drain D are formed to be physically continuous. Therefore, for example, it is permissible to draw out only source node S (or drain node D) as a capacitor node.

In case such the specifically patterned MOS capacitor is used, symbols thereof are used as shown in FIG. 31 in correspondence with FIGS. 8 to 15. In FIG. 31, example (a) corresponds to E-type NMOS transistor QNE; example (b) E-type PMOS transistor QPE; example (c) D-type NMOS transistor QND; example (d) N-channel well capacitor CN; and example (e) P-channel well capacitor CP.

It is also effective to deal with a device with the conventional transistor layout, in which source and drain are separated from each other, in such a way that one of source and drain serves as a capacitor node while the other is set in a floating state.

In the examples shown in FIGS. 1 to 3, both nodes of MOS capacitor C are coupled to circuit nodes set to be lower than the power supply voltage Vcc. However, the present invention is not limited to these examples, but it may be adapted to other circuits, in each of which one capacitor node of the MOS capacitor is fixed in potential.

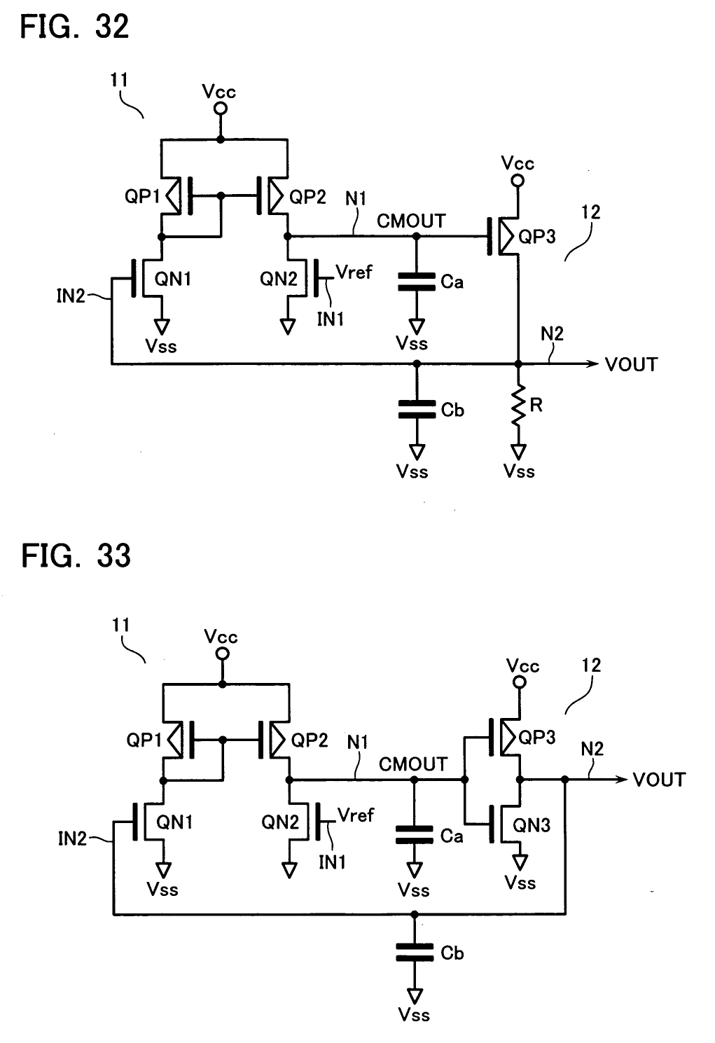

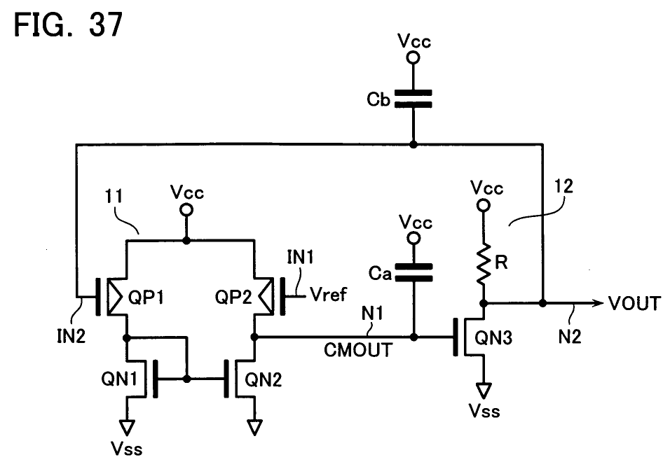

FIGS. 32 to 37 show such the voltage generation circuits. In these circuits, the same reference signs, marks and symbols are used in correspondence to those in FIGS. 1 to 3, and the detailed description will be omitted.

FIG. 32 shows a voltage generation circuit with basically the same configuration as that shown in FIG. 1, in which MOS capacitors Ca and Cb are connected to the output node CMOUT and the non-inverting input node IN2 (i.e., output node N2), respectively.

FIG. 33 shows a voltage generation circuit with basically the same configuration as that shown in FIG. 2, in which MOS capacitors Ca and Cb are connected to the output node N1 and the input node IN2, respectively.

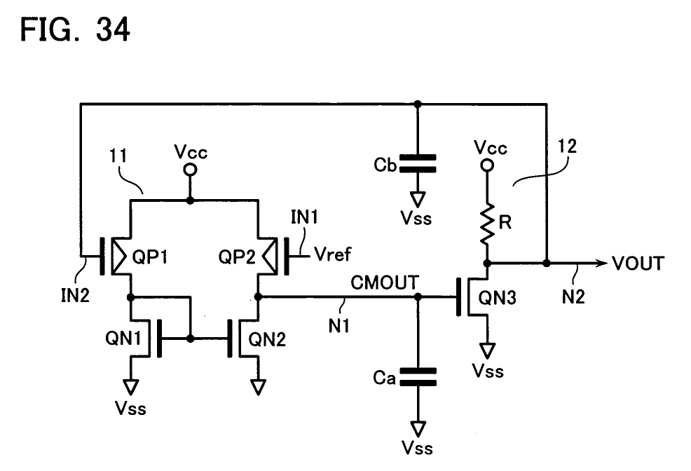

FIG. 34 shows a voltage generation circuit with basically the same configuration as that shown in FIG. 3, in which MOS capacitors Ca and Cb are connected to the output node N1 and the input node IN2, respectively.

In each circuit shown in FIGS. 33 to 34, one end of each of MOS capacitors Ca and Cb is fixed in potential (i.e., connected to ground potential node Vss).

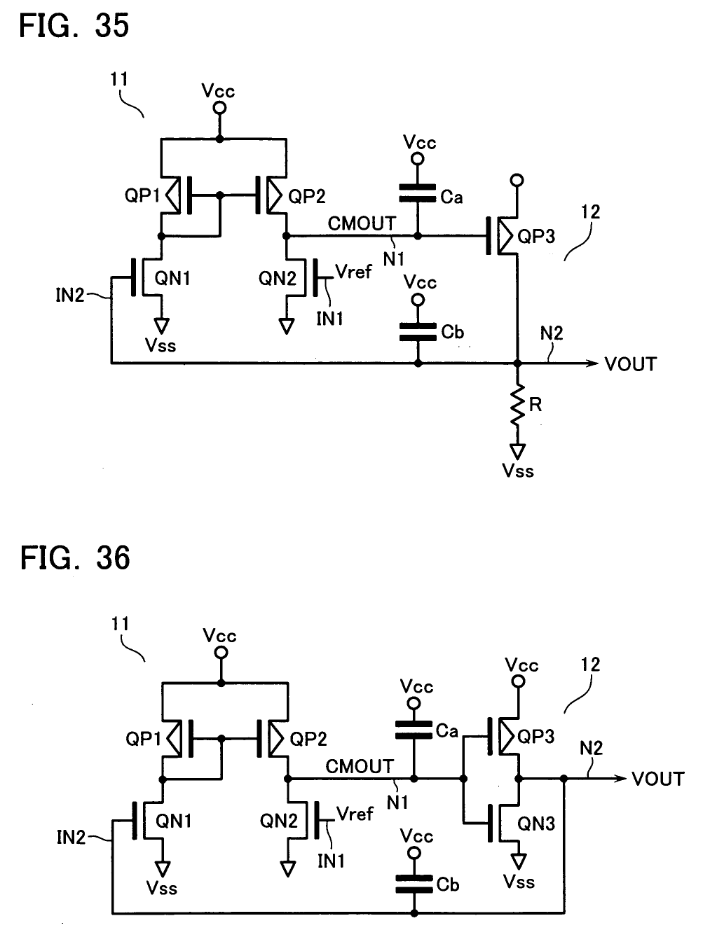

FIGS. 35 to 37 show variations of circuits shown in FIGS. 32 to 34, respectively, in each of which one capacitor node of each capacitor Ca, Cb is connected to the power supply node Vcc.

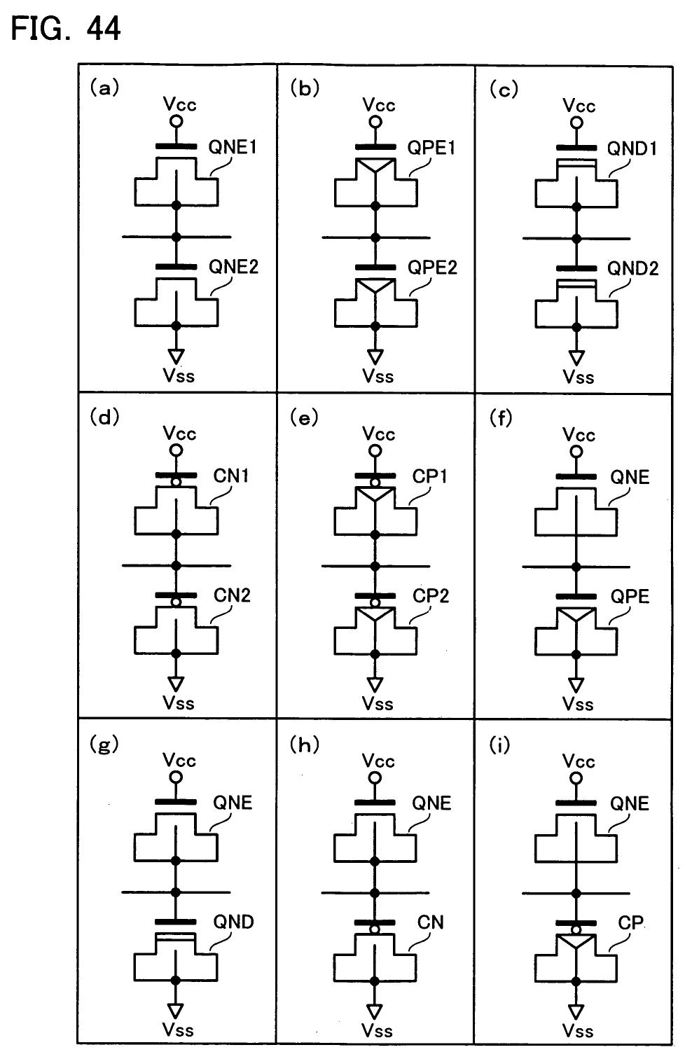

MOS capacitors Ca and Cb used in the voltage generation circuits shown in FIGS. 32 to 37, may be formed of parallel-connected MOS capacitors shown in FIGS. 4 to 7. In addition, MOS capacitors Ca and Cb used in the voltage generation circuits shown in FIGS. 32 to 37, in each of which is connected to Vss or Vcc, may also be formed of various combinations of two MOS capacitors shown in FIGS. 44 to 50.

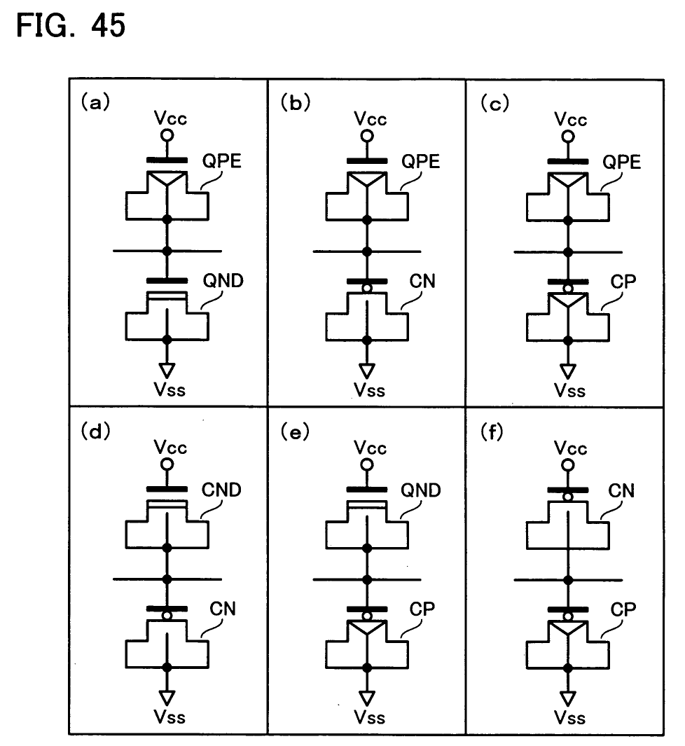

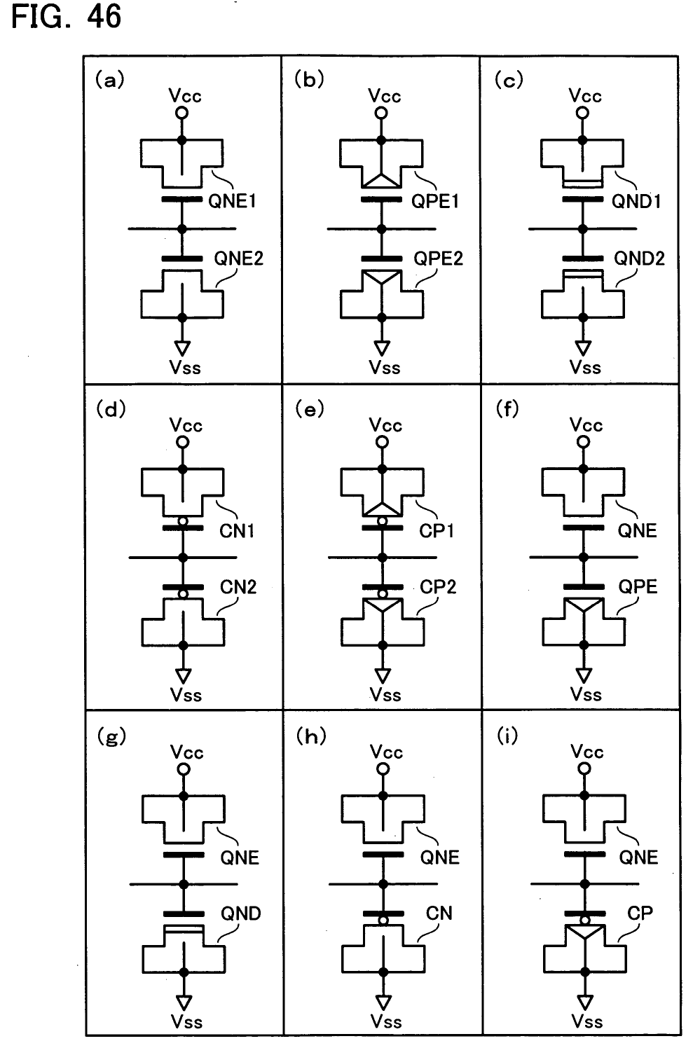

In FIGS. 44 and 45, source, drain and well of one of the two MOS capacitors and a gate of the other MOS capacitor are connected to a common node, which is connected to the circuit node N1 or IN2(N2). The remaining nodes of these two capacitors are connected to Vcc and Vss, respectively. Although these two MOS capacitors are connected in series between Vcc and Vss in a DC mode, these are connected in parallel with each other with the reverse directions in an AC mode, thereby being adaptable to the capacitors Ca and Cb shown in FIGS. 33 to 37, each one end of which is fixed in potential.

If each of the MOS capacitors Ca and Cb shown in FIGS. 32 to 37, in which each one end is connected to Vcc or Vss, is constituted by two MOS capacitors disposed in series between Vcc and Vss as shown in FIGS. 44 and 45, applied voltage changes of the two MOS capacitors due to the operation voltage change at the node N1 or IN2, which is set to be between Vcc and Vss, become different from each other. Therefore, the capacitance changes of these capacitors due to the operation voltage change may be suppressed in a small level as similar to the examples shown in FIGS. 4 to 7.

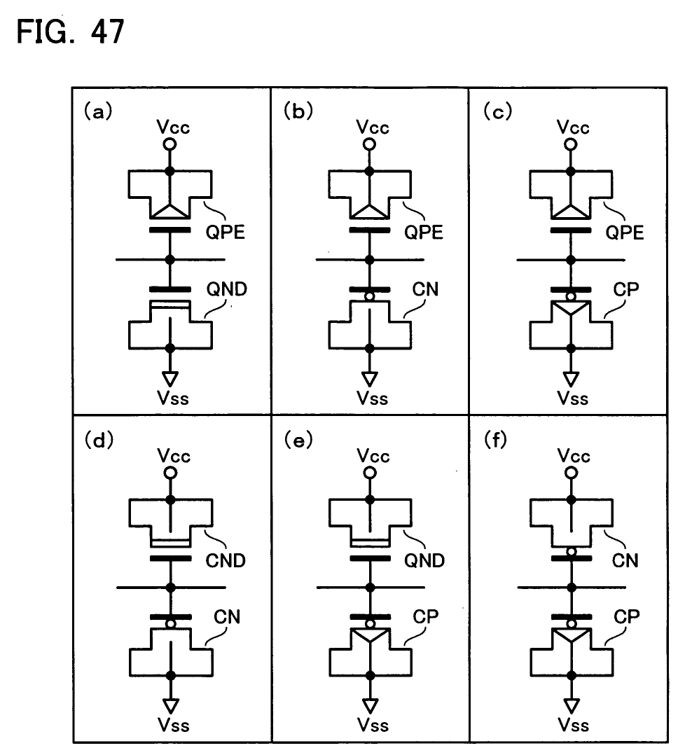

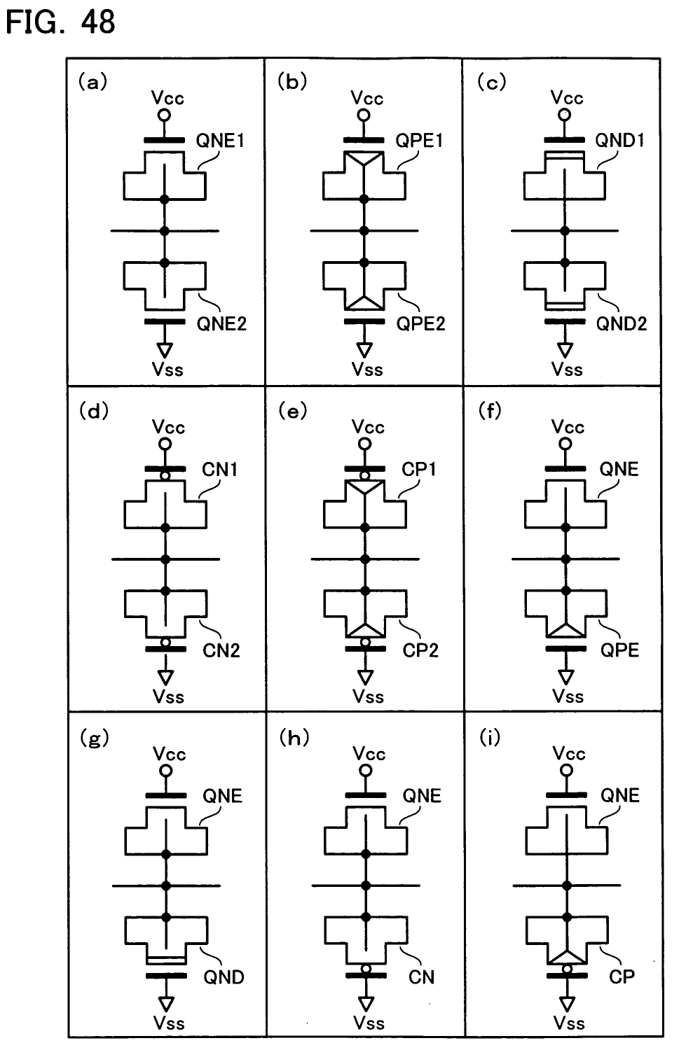

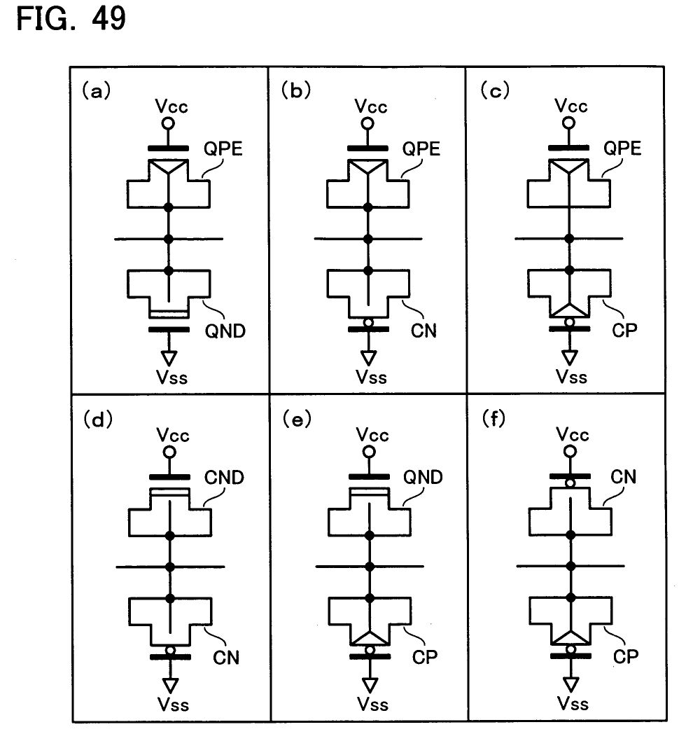

In each example shown in FIGS. 46 and 47, the gates of two MOS capacitors are connected in common to the circuit node N1 or IN2; the source, drain and well of one capacitor are connected to Vcc; and the source, drain and well of the other capacitor to Vss. In each example shown in FIGS. 48 and 49, the source, drain and well of two MOS capacitors are connected in common to the node N1 or IN2; the gate of one capacitor is connected to Vcc; and the gate of the other capacitor to Vss.

In these examples, as different from those shown in FIGS. 44 and 45, two capacitors are not connected in parallel with reverse directions. However, referring to, for example, a combination case of E-type NMOS capacitors QNE1 and QNE2 as shown in FIG. 46(a), the voltage change at the common node makes node-to-node voltages of the two capacitors change in the different directions from each other because one is connected to Vcc; and the other to Vss. Therefore, adapt the examples shown in FIGS. 46-49 to the voltage generation circuits shown in FIGS. 32 to 37, the capacitance variation due to the circuit node's voltage variation may be suppressed in a small level as well as in the above-described examples.

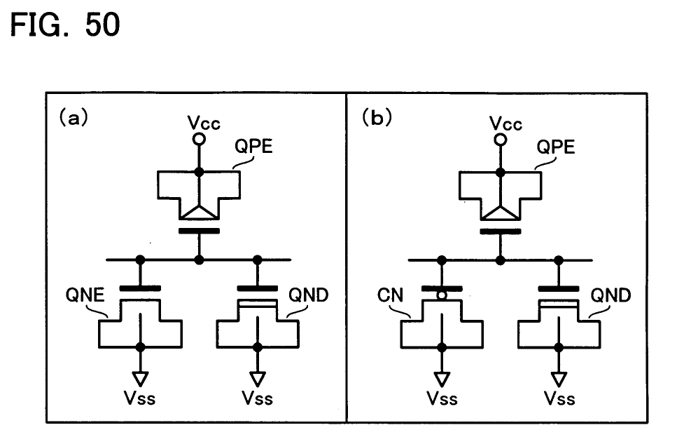

FIG. 50 shows two examples each formed of three MOS capacitors. In addition to those shown in FIG. 50, various variations with three MOS capacitors may be used.

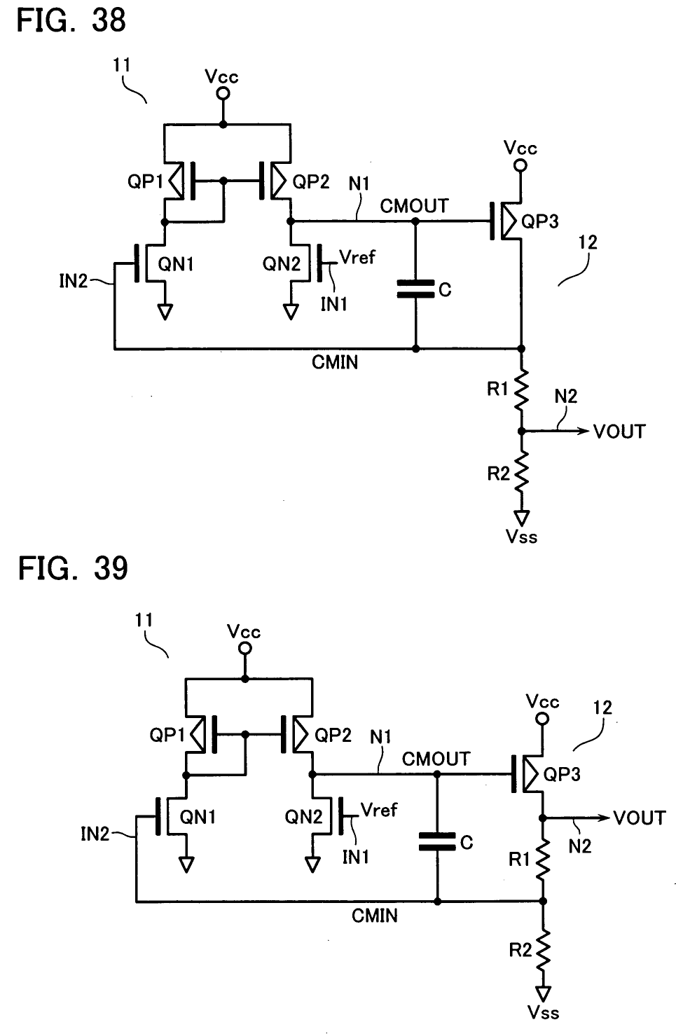

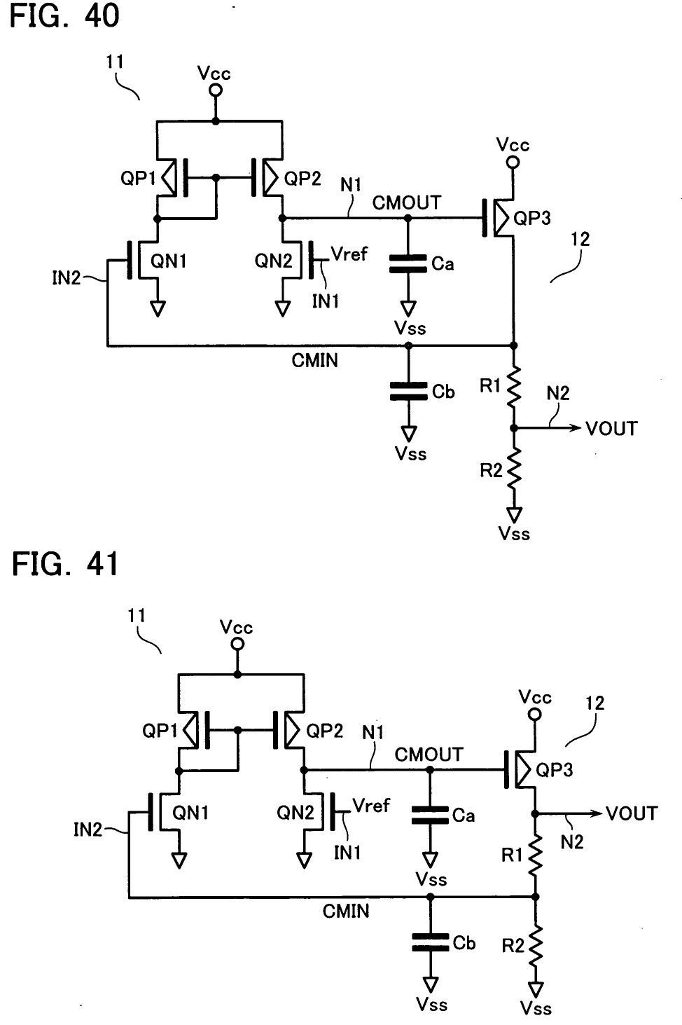

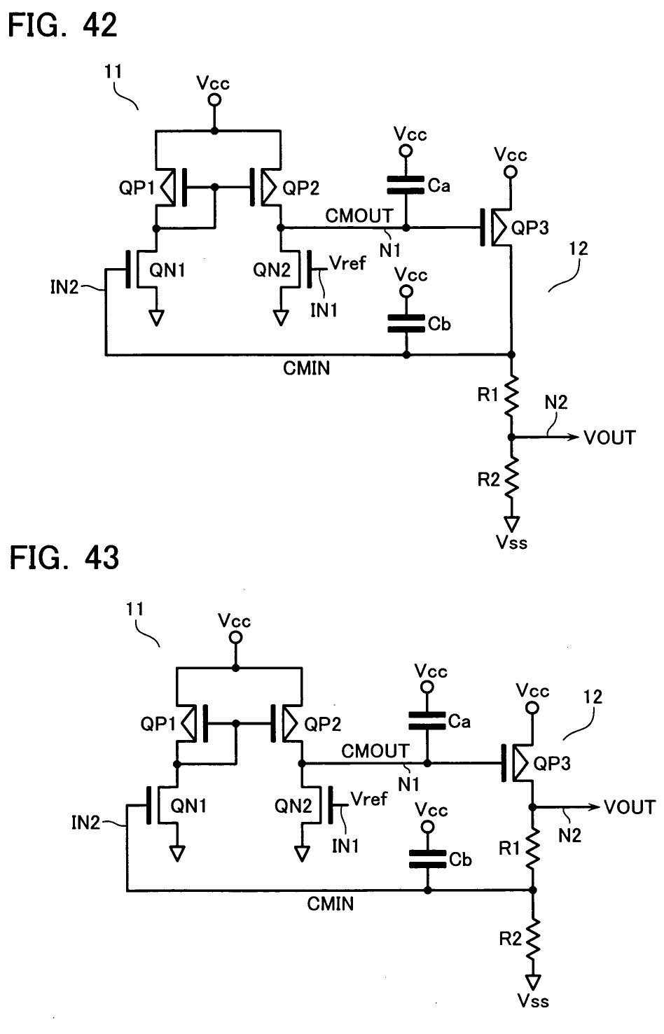

FIGS. 38 to 43 show voltage generation circuits in accordance with other embodiments. In FIG. 38, a voltage dividing circuit with resistors R1 and R2 is formed in the voltage output circuit 12 as similar to that shown in FIG. 1. The connection node between the resistors R1 and R2 serves as the voltage output node N2 for outputting the regulated voltage VOUT; and the connection node between transistor QP3 and the resistor R1 provides a feedback voltage CMIN to the input node IN2 of the differential amplifier 11.

Therefore, the output voltage VOUT is obtained by dividing the reference voltage Vref with the resistors R1 and R2. In this circuit arrangement, MOS capacitor is formed of parallel-connected MOS capacitors as well as the above-described embodiments, thereby providing the same advantageous effect as in the above-described embodiments.

By contrast to FIG. 38, in FIG. 39, the divided voltage, which is obtained by the voltage dividing circuit with the resistors R1 and R2, serves as the negative feedback voltage CMIN to the differential amplifier. FIGS. 40 to 43 show examples, in which capacitors Ca and Cb are independently connected to the nodes N1 and IN2, respectively, on the basis of the circuits shown in FIGS. 38 and 39. By use of the same MOS capacitors in these circuits as in the above-described embodiments, the same effect may be obtained as in the above-described embodiments.

This invention is not limited to the above-described embodiment, but various changes may be made, for example, as follows.

(1) In conventional LSI devices, a D-type PMOS transistor is not practically used, and E-type PMOS transistors with different threshold voltages from each other are not practically prepared. However, this invention is effective in such a case that a D-type of PMOS transistor is prepared in cooperation with an E-type of one, or PMOS transistors with different threshold voltages are coupled in parallel with other MOS capacitor(s).

(2) In the embodiments described above, MOS capacitors (i.e., MOS transistors) with different threshold voltages from each other are listed up as examples of different kinds of ones. As a method of providing the threshold voltage difference, not only a channel-doping method, which is usually used, but also a method of adjusting the gate insulating film thickness may be used.

(3) The voltage generation circuits with current-mirror types of differential amplifiers are used in the embodiments described above. The present invention is effective in such a case that the differential amplifier has other types of current-source loads. Further, except the voltage generation circuit, the present invention may be adapted to whatever circuits with a circuit node to be set lower that the power supply voltage and a voltage stabilizing capacitor connected to it.

What is claimed is:

1. A semiconductor integrated circuit device comprising:
a circuit node to be set at a certain operating voltage; and
a voltage stabilizing capacitor connected to the circuit node, wherein
the voltage stabilizing capacitor is formed of at least two MOS capacitors coupled in parallel with each other, which show different capacitance changes from each other in accordance with an applied voltage change.

2. The semiconductor integrated circuit device according to claim 1, wherein
the two MOS capacitors are formed of different types of MOS transistors, gate of each transistor serving as a first capacitor node; and at least one of source and drain of each transistor as a second capacitor node.

3. The semiconductor integrated circuit device according to claim 1, wherein
the two MOS capacitors are formed of first and second MOS transistors coupled with the reverse directions, gate of the first MOS transistor being coupled to at least one of source and drain of the second MOS transistor, gate of the second MOS transistor being coupled to at least one of source and drain of the first MOS transistor.

4. A semiconductor integrated circuit device comprising:
a differential amplifier; and
a voltage stabilizing capacitor connected between the input and output nodes of the differential amplifier, the voltage stabilizing capacitor being formed of at least two MOS capacitors coupled in parallel with each other, which show different capacitance changes from each other in accordance with an applied voltage change.

5. The semiconductor integrated circuit device according to claim 4, wherein
the two MOS capacitors are formed of different types of two MOS transistors, gate of each transistor serving as a first capacitor node; and at least one of source and drain of each transistor as a second capacitor node.

6. The semiconductor integrated circuit device according to claim 4, wherein
the two MOS capacitors are formed of first and second MOS transistors coupled with the reverse directions, gate of the first MOS transistor being coupled to at least one of source and drain of the second MOS transistor, gate of the second MOS transistor being coupled to at least one of source and drain of the first MOS transistor.

7. A semiconductor integrated circuit device with a voltage generation circuit, the voltage generation circuit comprising:
a differential amplifier having an inverting input node, a non-inverting input node and an output node, the inverting input node being applied with a reference voltage;
a voltage output circuit, the input node of which is coupled to the output node of the differential amplifier, the output voltage of the voltage output circuit being subjected to negative feedback to the non-inverting input node; and
a voltage stabilizing capacitor connected between the non-inverting input node and the output node of the differential amplifier, the voltage stabilizing capacitor being formed of at least two MOS capacitors coupled in parallel with each other, which show different capacitance changes from each other in accordance with an applied voltage change.

8. The semiconductor integrated circuit device according to claim 7, wherein
the two MOS capacitors are formed of different types of MOS transistors, the gate of each transistor serving as a first capacitor node; and at least one of the drain and source of each transistor as a second capacitor node.

9. The semiconductor integrated circuit device according to claim 7, wherein
the two MOS capacitors are formed of first and second MOS transistors coupled with the reverse directions, gate of the first MOS transistor being coupled to at least one of source and drain of the second MOS transistor, gate of the second MOS transistor being coupled to at least one of source and drain of the first MOS transistor.

10. The semiconductor integrated circuit device according to claim 7, wherein
the differential amplifier comprises: a current-mirror type of load circuit constituted by PMOS transistors; and a pair of differential NMOS transistors connected to the load circuit, the gates of which serve as the inverting and non-inverting input nodes, respectively, and wherein
the voltage output circuit comprises: a current source PMOS transistor, the gate and source of which are connected to the output node of the differential amplifier and a power supply node, respectively; and a load resistor connected to the drain of the current source PMOS transistor.

11. The semiconductor integrated circuit device according to claim 7, wherein
the differential amplifier comprises: a current-mirror type of load circuit constituted by PMOS transistors; and a pair of differential NMOS transistors connected to the load circuit, the gates of which serve as the inverting and non-inverting input nodes, respectively, and wherein
the voltage output circuit comprises a CMOS amplifier, the common gate of which is connected to the output node of the differential amplifier.

12. The semiconductor integrated circuit device according to claim 7, wherein
the differential amplifier comprises: a current-mirror type of load circuit constituted by NMOS transistors; and a pair of PMOS transistors, the gates of which serve as the inverting and non-inverting input nodes, respectively, and wherein
the voltage output circuit comprises: a current source NMOS transistor, the gate and source of which are connected to the output node of the differential amplifier and a ground potential node, respectively; and a load resistor connected to the drain of the current source NMOS transistor.

13. A semiconductor integrated circuit device comprising:
a differential amplifier having an inverting input node, a non-inverting input node and a first output node, the inverting input node being applied with a reference voltage;
a voltage output circuit, the input node of which is connected to the first output node of the differential amplifier, for outputting a regulated output voltage to a second output node, the regulated output voltage being subjected to negative feedback to the non-inverting input node;
a first voltage stabilizing capacitor, one node of which is coupled to the first output node, the other node being fixed in potential; and
a second voltage stabilizing capacitor, one node of which is coupled to the non-inverting input node, the other node being fixed in potential, wherein
each of the first and second voltage stabilizing capacitors is formed of at least two MOS capacitors coupled in parallel with each other, which show different capacitance changes from each other in accordance with an applied voltage change.

14. The semiconductor integrated circuit device according to claim 13, wherein
the two MOS capacitors are formed of different types of MOS transistors, the gate of each transistor serving as a first capacitor node; and at least one of the source and drain of each transistor as a second capacitor node.

15. The semiconductor integrated circuit device according to claim 13, wherein
the two MOS capacitors are formed of first and second MOS transistors coupled with the reverse directions, gate of the first MOS transistor being coupled to at least one of source and drain of the second MOS transistor, gate of the second MOS transistor being coupled to at least one of source and drain of the first MOS transistor.

16. The semiconductor integrated circuit device according to claim 13, wherein
one node of each MOS capacitor is connected to a power supply node or a ground potential node.

17. The semiconductor integrated circuit device according to claim 13, wherein
either of first and second capacitor nodes of one of the two MOS capacitors is connected to a power supply node; and either of first and second capacitor nodes of the other to a ground potential node.
